(19) United States
(12) Patent Application Publication
(10) Pub. No.: US 2014/0251944 A1
(43) Pub. Date: Sep. 11, 2014

(54) HAPPY BABY BOTTLE

(71) Applicant: NELSON JESUS SPINETTI, Mc Allen, TX (US)

(72) Inventor: NELSON JESUS SPINETTI, Mc Allen, TX (US)

(21) Appl. No.: 14/064,091

(22) Filed: Oct. 25, 2013

Related U.S. Application Data
(60) Provisional application No. 61/775,465, filed on Mar. 8, 2013.

(51) Int. Cl. A61J 9/00

(52) U.S. Cl. CPC A61J 9/00
USPC 215/365; 177/1

(57) ABSTRACT

The inventive device object of the present application is an ergonomically shaped bottle, which is designed to limit the possibility of taking larger than the infant's stomach size along or physiologic with the formula or any other infant nutritious liquid, If parents follow the happy baby bottle mathematically designed feeding scale on the side of the bottle, the baby will receive the appropriate amount of formula per feeding every 3 to 3½ hours apart so they will not suffer the various maladies caused by overfeeding. It is emphasized that this abstract is provided to comply with the rules requiring an abstract that will allow a searcher or other reader to quickly ascertain the subject mater of the technical disclosure.

### CLAIM OF PRIORITY FROM RELATED APPLICATIONS

The present application claims priority from U.S. Provisional Patent Application No. 61/775,465 filed on Mar. 8, 2013 to Nelson J. Spinetti from McAllen (Tex.), directed to THE HAPPY BABY BOTTLE, that is hereby incorporated by reference.

### BACKGROUND OF THE INVENTION

1. Field of the Invention

The inventive device disclosed in the present application generally relates to baby feeding bottles and more specifically to an ergonomically shaped bottle, which is designed to limit the possibility of taking larger than the infant's stomach size or physiologic along with the formula or any other infant nutritious liquid, If parents follow the happy baby bottle mathematically designed feeding scale on the side of the bottle, the baby will receive the appropriate amount of formula per feeding so they will not suffer the various maladies caused by overfeeding.

2. Brief Description of the Prior Art

Baby feeding bottles are well known in the art. Various Patents and Published Patent applications are in fact directed to baby feeding bottles. While developing the invention of the instant application independently the Inventor researched extensively the public record as well as the current market for calibrated baby feeding bottles and the most relevant examples found in the search are mentioned in the Information Disclosure Statement (IDS) attached.

Despite all the efforts listed above prior art patents describe structures that are either not truly convenient or else involve complicated, expensive, and overly difficult assembly and/or disassembly parts and procedures. Other devices have been advertised on various media but never patented or described into a printed publication.

### SUMMARY OF THE INVENTION

The inventive device object of the present application is an ergonomically shaped bottle, which is mathematically designed feeding scale that corrects to optimal feeding volume and to limit the possibility of taking larger than the infant's stomach size or physiologic feeding volume of formula or any other infant's nutritious feeding liquid, If parents follow the happy baby bottle mathematically designed feeding scale on the side of the bottle, the baby will receive the appropriate amount of formula per feeding every 3 to 3½ hours apart so they will not suffer the various maladies caused by overfeeding.

It is then the principal object of the present invention is to prevent overfeeding of the baby may reduce the possibilities of reflux, spitting up. colicky, abdominal pain, distension, abnormal stool pattern, apnea due to GERD, unnecessary formula changes and/or unnecessary hospitalizations.

It is a secondary objective of the present invention to eliminate irritability, bad sleep patterns the child and the adult developing obesity problems and many health problems can develop when babies are not fed correctly.

It is an additional objective of the present invention to provide a device that does not rust or deteriorate over time and may be safely used to store and preserve food for human consumption. It is a final objective of the present invention to provide for a device that is relatively inexpensive to build, but that can eventually be sold at a premium.

These and other objective achieved by the device of the present invention will be apparent by the drawings, by their detailed description, and by the specification here from appended.

### BRIEF DESCRIPTION OF THE DRAWINGS

FIG. 1 is a front elevation view of one of the preferred embodiments of “The Happy Baby bottle” in accordance with the teachings of the present invention.

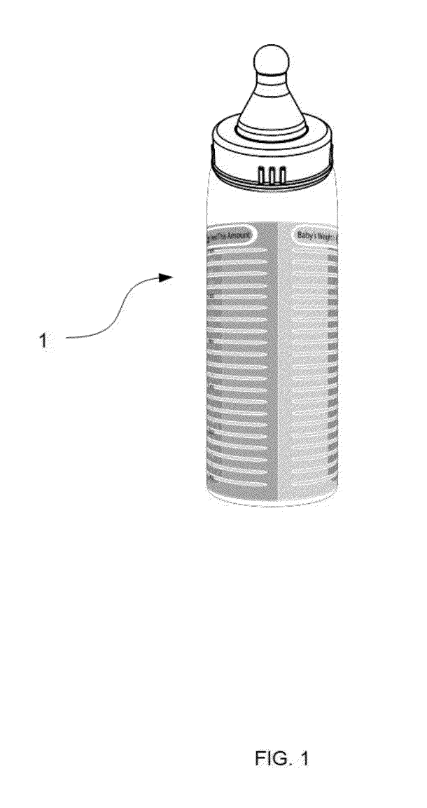

FIG. 2 is a left side elevation view of “The Happy Baby bottle” of FIG. 1.

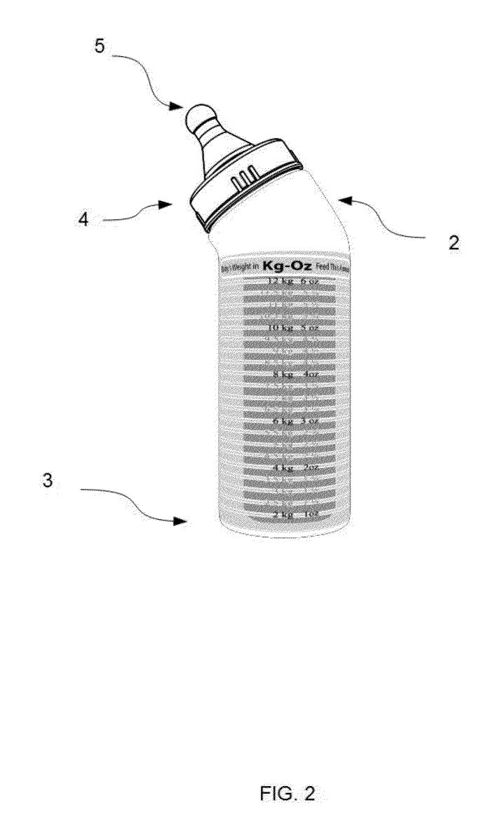

FIG. 3 is a right side elevation view of “The Happy Baby bottle” of FIG. 1.

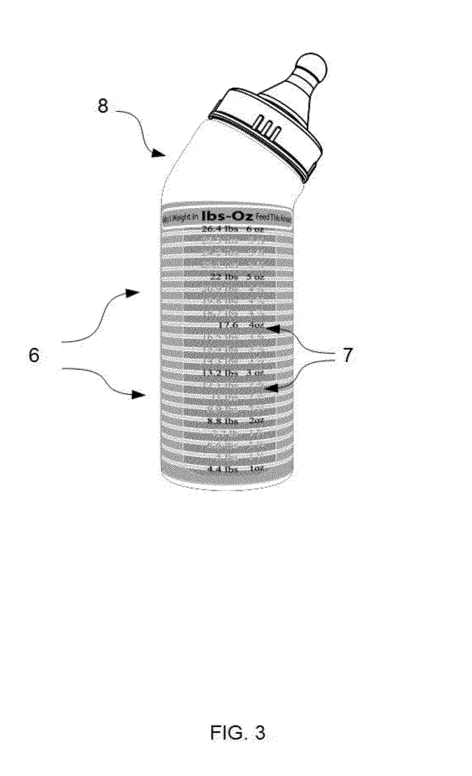

FIG. 4 is a back side elevation view of “The Happy Baby bottle” of FIG. 1.

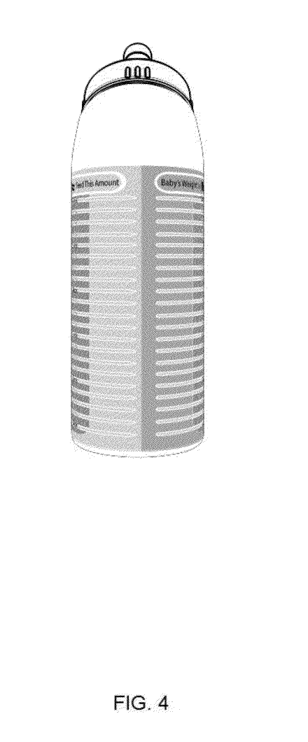

FIG. 5 is a top elevation view of “The Happy Baby bottle” of FIG. 1.

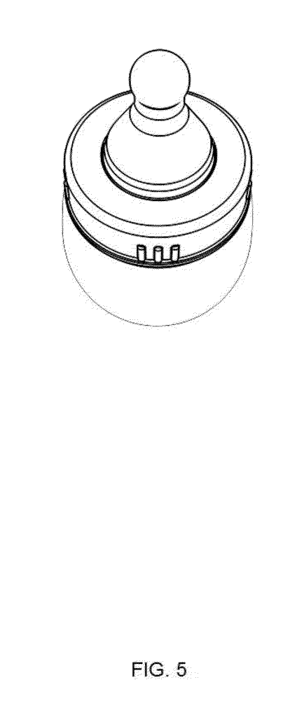

FIG. 6 is a bottom elevation view of the “The Happy Baby bottle” of FIG. 1.

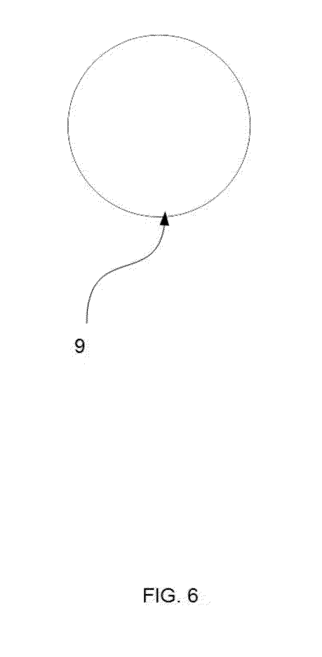

### DESCRIPTION OF THE PREFERRED EMBODIMENT

The inventive device object of the present application is an ergonomically shaped bottle, which is designed to limit the possibility of taking larger than the infant's stomach size along or physiologic with the formula or any other infant nutritious liquid, If parents follow the happy baby bottle mathematically designed feeding scale on the side of the bottle, the baby will receive the appropriate amount of formula per feeding every 3 to 3½ hours apart so they will not suffer the various maladies caused by overfeeding. As it can be inferred from the drawings essential components of the “The Happy Baby bottle” of the present application include: various baby bottle nipples, 3, 6, and 9 Oz bottles, and a cap.

One anthropometric or unique infant's feature from the infant will dictate the amount for the exact amount to feed that will prevent overfeeding side effect and reflux in infant. In one preferred embodiment of “The Happy Baby bottle” of the present application the nipple feature as cross cut tip as bi, triple, and/or four left to let allow for a proper regulation of the speed of milk flow independent from the thicken and or concentration of the liquid formula.

In a further separate preferred embodiment of “The Happy Baby bottle” the device has no sharp edge at bottom and or small dilation of the bottle to facilitate proper mix powder formula and liquid (as water).

A mathematics formula combined with an algorithm are used to calculate the exact formula amount to maximize feeding nutrition and prevent side effects. Generally speaking everything in pediatrics should be calculate by body weight or body surface to properly calculate the exact amount from medication, fluid and nutrition, also in the medical world all important medication and critical medication will be calculated by one or multiple body features.

In the specific the amount of liquid (fluid or formula) is calculate by a combination of this formula 120 to 160 cm³ per kg per day divide by 8 deliver every 3 hours. Using weight in pounds as body weight in kg (kilograms) divided by 2 or body weight in lb (pounds) multiple by 0.22 plus/minus 0.5 oz will adjust the variance for stomach size and standard human variances. With this mathematically designed scale, if the caregiver only knows the weight (lbs or Kg) the scale will automatically highlighted and indicate the exact volume in ounce, cm³, cc or ml to properly feed the infant, the feeding amount every 3 hours. The table is summary of knowledge and experience of the right volume that will accommodate the infant stomach size. Also this is the uniqueness of the present invention and how we transform from infant weight or anthropometric to the right volume to feed the infant and the summary of the mathematics relationship between weight and proper feeding.

the chart printed on the outside of The Happy Baby Bottle gives parents and caretakers the recommended amounts for each feeding. The measurements for the babies' weight and for the amount to be fed to the babies are provided in Ounces or milliliters, and pounds or kilograms so the bottle can be universally used. The scale uses the baby's most recent weight that could be determined at the primary physician's office or at home with the infant proper balance method. Technically speaking reflux and infant feeding, physic in the stomach size equally applies. If a volume container or the stomach size is equal or larger than the amount of liquid to feed, the feeds will be properly maintained inside the infant's stomach. And the appositive is also true, if the feeds or liquid volume is larger than the container or stomach capacity this volume cannot be contained and vomiting, reflux, diarrhea and colic will occur in the infant.

The premise is that the baby's stomach size is related to the baby's weight. The amounts listed on the bottle have been tested and are optimum amounts to feed a baby with that particular weight. When a baby is fed too much for the size of its stomach, vomiting, regurgitation, GERD, and colic can result. If the baby is fed too little it will be hungry ceand fail to thrive. Other illnesses and conditions can develop from incorrect feeding habits.

The parent can find the baby's weight on the chart and move across to find the correct amount to feed, which can be safely adjusted by 0.5 ounces. When using these bottles, certain other guidelines should be followed. It is suggested that the amount fed to the baby be increased by ¼ ounce per week or, 1 ounce per month, since the date the last weight was obtained. Weighing the baby the next time will provide a new starting point on the chart.

To enhance digestion the baby should be fed 8 times a day or on a schedule of every three hours. The bottles should be cleaned and sterilized as usual between feedings. Bottles should be translucent so the level of the fluid can be easily identified and available in sex coding colors allowing the caregiver to interact and to engage better with the infant such as blue for boy, light pink for girl and yellow for neutral when caregivers are engaged.

In one of its preferred embodiments the present application discloses a method for calculating the proper amount of formula for feeding for an infant consisting of the steps of: determining the body mass of the infant in Kg; calculating the daily dose of formula by multiplying said body mass in Kg times a feeding factor expressed in cm³ per Kg of body mass; calculating the amount of formula for each feeding by dividing the product obtained by multiplying said body mass in Kg times a feeding factor expressed in cm³ per Kg of body mass by 8. The feeding factor is a number experimentally determined to be comprised in between 120 and 160 cm³ per Kg or infant body mass.

For example if it is determined that an infant has reflux problems, absent any other issues it's placed on a scale and weighted. It is determined that his body mass is fifteen kilograms (15 Kg). His body mass is multiplied by 140 cm³ per Kg or body mass to determine the daily dose. The daily dose obtained is 2,100 cm³. The daily dose of 2,100 cm³ is divided by 8 to calculate the amount of formula for each feeding. Thus the amount of formula for each feeding is 262.5 cm³. The feeding process is then completed by feeding the infant with said amount of formula for each feeding every set time interval, where said set time interval is in between 3 and 3.5 hours.

Infant formula is a manufactured food designed and marketed for feeding to babies and infants under 12 months of age, usually prepared for bottle-feeding or cup-feeding from powder (mixed with water) or liquid (with or without additional water). The U.S. Federal Food, Drug, and Cosmetic Act (FFDCA) defines infant formula as “a food which purports to be or is represented for special dietary use solely as a food for infants by reason of its simulation of human milk or its suitability as a complete or partial substitute for human milk”. For the purpose of the present application the term formula include yogurt, and milk, including cow milk, sheep or goat milk, and human milk.

a simplified, but equivalent, version of the method for calculating the proper amount of formula for feeding for an infant described above is to divide the infant weight in kilogram by 2. The number obtained represents the correct feeding in every feeding time. The number obtained is number in ounces and it represents the ounce per feeding. The actual feeding could be adjusted but a factor of 0.5 ounces (oz) as plus or minus 0.5 oz upon the infant specific needs. With regard to the example above after it is determined that the body is 5 kg by dividing that by a factor of 2 the result will be 5 kg/2 kg/oz it is equal to 2.5 ounce per feeding +/−0.5 every 3-3.5 hours. This shortened version has the advantage of being easier and more immediate. The feeding process is the completed by feeding the infant with said amount of formula for each feeding every set time interval, where said set time interval is in between 3 and 3.5 hours.

In one of its preferred embodiments the inventive device of the present application embodies into a baby bottle for feeding an infant with a measured amount of formula comprising a generally cylindrical baby bottle (1), having two ends a top end (2) and a bottom end (3); where said top end is open to engage a cap (4) from which a rubber nipple (5) protrudes outwardly; said generally cylindrical baby bottle bearing printed indicia (6) representing a scale (7) built by determining the body mass of the infant in Kg; calculating the daily dose of formula by multiplying said body mass in Kg times a feeding factor expressed in cm³ per Kg of body mass; calculating the amount of formula for each feeding by dividing the product obtained by multiplying said body mass in Kg times a feeding factor expressed in cm³ per Kg of body mass by 8. In a separate preferred embodiment of the baby bottle for feeding an infant with a measured amount of formula of the present application the upper portion (8) of said cylindrical baby bottle (1) just underneath said top end (2) is bended 45 degrees. In a further separate preferred embodiment of the baby bottle for feeding an infant with a measured amount of formula of the present application said bottom end of said cylindrical baby bottle has a small dilation (9) to easy the process of mixing the powered formula with the water solvent.

A method for calculating the proper amount of formula for feeding for an infant consisting of the steps of: determining the body weight of the infant in kilograms Kg; calculating the daily dose of formula for a factor of 140 Milliliter (ml or cc) multiple by infant weight in kg results in proper calories and liquid on the 50% le for infant growth. And adjustment of 100 cc to 180 cc per kg per day could be needed on very specific infant requirements, so the range I claimed for calculating the infant stomach size is between 100 cc to 180 cc per Kg per day. The method for calculating the proper amount of formula for feeding for an infant of claim 1 where the numerical value of said feeding factor expressed in cc or ml per Kg is between 100 cc to 180 cc. The method for calculating the proper amount of formula for feeding for an infant of claim 1 further comprising the step of feeding the infant the amount of formula for each feeding every set time interval, 140 cc per kg per day give a X amount; X amount divide by factor of 8 or 7 to have the 3 to 3.5 hours interval set schedule time. Example 5 kg infant should eat as: 5 kg×140 cc per kg equal to 700 cc per day 87.5 cc (2¾ to 3 oz) per feeding every 3 hours. The baby bottle for feeding an infant with a measured amount of formula of claim 9 where the numerical value of said feeding factor expressed centimeter cubic per kg of body weight is between 100 and 180. The baby bottle for feeding an infant with a measured amount of formula of claim 9 where the upper portion of said cylindrical baby bottle is straight or bended in 45 degrees angle.

### Example One

infant was seen by one previous pediatric gastroenterologist for 3 months multiple formula changed and medication as proton pump inhibiter/prokinetic as erythromycin and raglan were use with nor respond to vomiting and abdominal pain. Adjusting feeding to proper feeding volume resolve the infant symptoms in only one visit.

### Example Two

infant with abdominal pain diarrhea, abdominal pain and vomiting evaluated by 3 different pediatrician as well multiple formula changed and evaluation did no improve the infant symptoms adjusting feeding and education of the family to continue on proper feeding resolved the symptoms on no new formula and no additional medication and no need to other new test.

### Example Three

infant hospitalize with gastrostomy tube severe abdominal pain, abdominal distension and diarrhea, hospitalized at intermediate therapy evaluated by intensivist and pediatric surgery did not resolved symptoms despite intense therapy with proton pump inhibitor and prokinetic until proper volume and per feeding time was began. This infant was dismiss from hospital after 3 days after 60 days of struggling with improper feeding techniques.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. a method for calculating the proper amount of formula for feeding for an infant consisting of the steps of: determining the body mass of the infant in Kg; calculating the daily dose of formula by multiplying said body mass in Kg times a feeding factor expressed in cm³ per Kg of body mass; calculating the amount of formula for each feeding by dividing the product obtained by multiplying said body mass in Kg times a feeding factor expressed in cm³ per Kg of body mass by 8.

2. The method for calculating the proper amount of formula for feeding for an infant of claim 1 where the numerical value of said feeding factor expressed in cm³ per Kg of body mass is between 120 and 160.

3. The method for calculating the proper amount of formula for feeding for an infant of claim 1 further comprising the step of feeding the infant the amount of formula for each feeding every set time interval.

4. The method for calculating the proper amount of formula for feeding for an infant of claim 3 where said set time interval is between 3 and 3.5 hours.

5. A method for calculating the proper amount of formula for feeding for an infant comprising the steps of determining the body mass of an infant; calculating the dose of a single feeding in liquid ounces by dividing the body mass (in Kg) of the infant by 2 liquid ounces per kilogram of mass of the infant.

6. The method for calculating the proper amount of formula for feeding for an infant of claim 5 further comprising the step of converting the dose of a single feeding in liquid ounces from liquid ounces to cm3 by multiplying said dose of a single feeding in liquid ounces times 29.57 cm³ per ounce.

7. The method for calculating the proper amount of formula for feeding for an infant of claim 1 further comprising the step of feeding the infant the amount of formula for each feeding every set time interval.

8. The method for calculating the proper amount of formula for feeding for an infant of claim 7 where said set time interval is between 3 and 3.5 hours.

9. A baby bottle for feeding an infant with a measured amount of formula comprising a generally cylindrical baby bottle, having two ends a top end and a bottom end; where said top end is open to engage a cap from which a rubber nipple protrudes outwardly; said generally cylindrical baby bottle bearing printed indicia representing a scale built by determining the body mass of the infant in Kg; calculating the daily dose of formula by multiplying said body mass in Kg times a feeding factor expressed in cm³ per Kg of body mass; calculating the amount of formula for each feeding by dividing the product obtained by multiplying said body mass in Kg times a feeding factor expressed in cm³ per Kg of body mass by 8.

10. The baby bottle for feeding an infant with a measured amount of formula of claim 9 where the numerical value of said feeding factor expressed in cm³ per Kg of body mass is between 120 and 160.

11. The baby bottle for feeding an infant with a measured amount of formula of claim 9 where the upper portion of said cylindrical baby bottle is bended 45 degrees.

12. The baby bottle for feeding an infant with a measured amount of formula of claim 9 where said bottom end of said cylindrical baby bottle has a small dilation.
